(19) United States
(12) Patent Application Publication
(10) Pub. No.: US 2023/0315025 A1
(43) Pub. Date: Oct. 5, 2023

(54) SYSTEMS AND METHODS FOR PREDICTIVE CLOCK MODELING

(71) Applicant: CACI, INC.- FEDERAL, Reston, VA (US)

(72) Inventor: George G. CASTLE, Reston, VA (US)

(21) Appl. No.: 18/328,155

(22) Filed: Jun. 2, 2023

Related U.S. Application Data
(60) Provisional application No. 62/420,866, filed on Nov. 11, 2016.

(51) Int. Cl. G04R 20/06; G01S 19/25

(52) U.S. Cl. CPC G04R 20/06; G01S 19/256

(57) ABSTRACT

The present application at least describes a method for predictive clock modeling. The method may include a step of collecting a characteristic of a first clock disposed therein via a first node. The method may also include a step of collecting a characteristic of a second clock disposed therein via a second node. The method may also include a step of receiving an instance of time of the first clock via the first node. The method may further include a step of receiving an instance of time of the second clock via the second node. The method may even further include a step of causing to determine a time offset and/or frequency offset between the first and second clock via a model based on the collected characteristic and the received instance of time from each of the first and second nodes. The method may yet even further include a step of transmitting an indication of the determined time offset and/or frequency offset output from the model to the second node.

### CROSS-REFERENCE TO RELATED APPLICATION

This application claims priority to U.S. Provisional Application No. 62/420,866, filed Oct. 31, 2022, entitled “Methods and Systems for Controlling Timing Capability,” which is incorporated by reference herein in its entirety.

### FIELD

This application generally relates to systems, apparatuses and methods to improve synchronization between clocks generally residing in separate locations.

### BACKGROUND

Precision timing may include one of three main technologies. The first technology may include GPS receivers which provide 10-20 nanosecond accuracy. The second technology may include atomic clocks which provide 0.1 nanosecond or better accuracy. This may include chip scale atomic clocks (CSACs). The third technology may include high quality ovenized crystal oscillators (OXCOs) which may provide roughly similar or better accuracy as CSACs.

GPS receivers determine time from a GPS constellation. The GPS constellation is calibrated to the coordinated universal time (UTC) maintained at the National institute of Standards and Technology (NIST). However, GPS receivers are vulnerable to local jamming, spoofing and/or a constellation-wide outage. As a result, GPS receiver may pose reliability and cybersecurity threats.

Thus, what is desired in the art is a technique and architecture that does not rely upon global navigation satellite system (GNSS).

What is also desired in the art is a technique and architecture that is independent of UTC or another global standard.

### SUMMARY

The foregoing needs are met, to a great extent, by the disclosed systems, methods, and techniques for improving synchronization between clocks.

One aspect of the patent application is directed to a method for predictive clock modeling. The method may include a step of collecting a characteristic of a first clock disposed therein via a first node. The method may also include a step of collecting a characteristic of a second clock disposed therein via a second node. The method may also include a step of receiving an instance of time of the first clock via the first node. The method may further include a step of receiving an instance of time of the second clock via the second node. The method may even further include a step of causing to determine a time offset and/or frequency offset between the first and second clock via a model based on the collected characteristic and the received instance of time from each of the first and second nodes. The method may yet even further include a step of transmitting an indication of the determined time offset and/or frequency offset output from the model to the second node.

Another aspect of the application describes a system for predictive clock modeling. The system includes a non-transitory memory including instructions stored thereon. The system also includes a processor operably coupled to the non-transitory memory configured to execute a set of the instructions. One of the instructions may include collecting a characteristic of a first clock disposed therein via a first node. Another one of the instructions may include collecting a characteristic of a second clock disposed therein via a second node. Yet another one of the instructions may include receiving an instance of time of the first clock via the first node. A further one of the instructions may include receiving an instance of time of the second clock via the second node. Even a further one of the instructions may include causing to determine a time offset and/or frequency offset between the first and second clocks via a model based on the collected characteristic and the received instance of time from each of the first and second nodes. The clock may include one or more of a crystal oscillator, a chip scale atomic clock, or an atomic clock including rubidium gas cells, cesium beams or hydrogen masers.

There has thus been outlined, rather broadly, certain embodiments of the application in order that the detailed description thereof herein may be better understood, and in order that the present contribution to the art may be better appreciated. There are, of course, additional embodiments of the application that will be described below and which will form the subject matter of the claims appended hereto.

### BRIEF DESCRIPTION OF THE DRAWINGS

To facilitate a fuller understanding of the application, reference is made to the accompanying drawings, in which like elements are referenced with like numerals. These drawings should not be construed to limit the application and are intended only for illustrative purposes.

FIGS. 1A-1B illustrate block diagrams of example systems according to an aspect of the application.

FIG. 2 illustrates an example user equipment device according to an aspect of the application.

FIG. 3 illustrates a block diagram of an example computing system according to an aspect of the application.

FIG. 4 illustrates an example system according to an aspect of the application.

FIG. 5 illustrates an example modeling system according to an aspect of the application.

FIG. 6 illustrates an example modelling of raw and corrected offset times between two clocks according to an aspect of the application.

FIG. 7 illustrates an example method flow chart according to an aspect of the application.

### DETAILED DESCRIPTION

Before explaining at least one embodiment of the application in detail, it is to be understood that the application is not limited in its application to the details of construction and to the arrangements of the components set forth in the following description or illustrated in the drawings. The application is capable of embodiments in addition to those described and of being practiced and carried out in various ways. Also, it is to be understood that the phraseology and terminology employed herein, as well as the abstract, are for the purpose of description and should not be regarded as limiting.

Reference in this application to “an aspect,” “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not for other embodiments.

Broadly, the present application provides a new approach to improve synchronization, e.g. matching times, of two or more clocks by accurately measuring their time difference. In addition, the present application may also improve syntonization, e.g., matching frequencies, of two or more clocks.

In one or more embodiments, the present application may describe systems and techniques to improve timing and frequency output for clocks, such as for example, crystal oscillators, CSACs, or an atomic clock including rubidium gas cells, cesium beams or hydrogen masers. In so doing, it will be shown that the impacts of frequency drift and offset on precision timing between clocks may be significantly reduced. Moreover, the impacts of environmental influences on precision timing between clocks may also be reduced.

In addition, the architecture and associated techniques of at least one aspect may be configured such that it does not rely upon GNSS. The architecture and associated techniques may be independent of UTC or another global standard.

The benefits envisaged by this current application will be clearly evident in terms of energy efficiency, cost and size. This may at least be attributed to OXCOs and CSACs employed in systems being power-hungry in comparison to atomic clocks.

It is clearly envisaged for the present application to be employed in many different industries. For example, precision timing architectures and techniques would be considerably relevant in the field of satellites communication networks, radiofrequency sensors, medical treatment, weaponry and financial trading systems to name just a few. Broadly speaking, the techniques and systems described herein are understood to be employed in any technology with existing and unmet needs for precision timing and longer holdover times between synchronization.

### Factors Affecting Clock Performance

It is generally understood that clocks run at different rates. In other words, no two clocks are identical. For instance, any two clocks will report slightly different times at any given instance. The time difference between the two clocks also may invariably change over time.

If the frequency difference between two clocks could be eliminated, the clocks could be synchronized once and subsequently provided the same time reading at any instance in the future. However, several reason make this impossible. First, all clocks are subject to “phase noise” which is noise involved in reading the time. This noise has a particular spectrum for each clock and is a random process. Hence it is unpredictable except in its statistical characteristics.

Second, clocks may be impacted by environmental factors. Environmental factors may include but are not limited to barometric pressure, temperature, acceleration, vibration and radiation exposure. A clock's sensitivity to each of these environmental factors may be measured and its effect on clock frequency may be computed in real-time.

Third, clocks experience frequency offset and frequency drift. Frequency offset is the difference between a true clock frequency and its nominal frequency. And frequency drift, e.g., aging, is an undesired progressive change in frequency with time. Frequency drift may occur in either direction causing higher or lower frequencies and thus may not be linear.

### OXCOs and CSACs

Ovenized crystal oscillators (OCXO) may generally include a crystal based oscillator, a temperature control system, and support circuitry surrounded by a layer of thermal insulation. This may all be enclosed in a sealed metal outer layer. In order to maintain a constant temperature within the oven, there must be a balance of power input to the oven with heat flowing out of the oven. The temperature is kept constant by adjusting the amount of power supplied to the oven whenever the ambient temperature in the oven begins to change. The oven minimizes the degree to which the frequency of the oscillator will vary with variations in temperature.

Inside the oven, the crystal is generally preserved between 70-90° C. This may be based on the turnover point of the crystal where the frequency versus temperature response is nominally flat. In other words, the selected oven temperature is one where the slope of the frequency versus temperature curve is zero.

On the other hand, chip scale atomic clocks (CSACs) employ vapor cells that enclose vapors of alkali metals, such as for example rubidium (Rb) or cesium (Cs). A laser sends a signal at an optical wavelength through the vapor cell, exciting hyperfine transitions using a phenomenon called coherent population trapping (CPT). For example, there may be a cesium-based CSAC with a laser that is tuned to the Dl absorption line of cesium at 894 nm. The laser sweeps a frequency region around the absorption line and monitors the amount of the light absorbed passing through the vapor cell. The region of maximum absorption is detected and used to stabilize a reference frequency that is provided by the CSAC. The intrinsic noise in the system can hamper attempts to increase sensitivity in the measurements. It is generally known that some CSACs become inaccurate when the ambient temperature changes. This is due to the CSAC's components, specifically the vapor cell and the VCSEL, not operating at their most stable temperatures.

In one or more embodiments, the oscillator may be packaged with any one or more of an accelerometer, barometer or temperature sensor. The outputs from one or more of these sensors may be digitized and/or combined and subsequently transmitted downstream to provide a real-time correction to time and/or frequency outputs to one or more clocks.

### System Architecture

According to a first aspect of the present application, systems and techniques are described to estimate known or predictable components of a clock pair in order to forecast with a high degree of accuracy time and frequency offsets between two or more clocks for a fixed or indeterminate amount of time. The technology could also be employed in unmanned aerial system (UAS) swarms or satellite clusters to perform relative timing synchronization and syntonization. Commercial applications could include synchronizing clocks at cellular towers or at financial institutions to support activities like high-frequency trading.

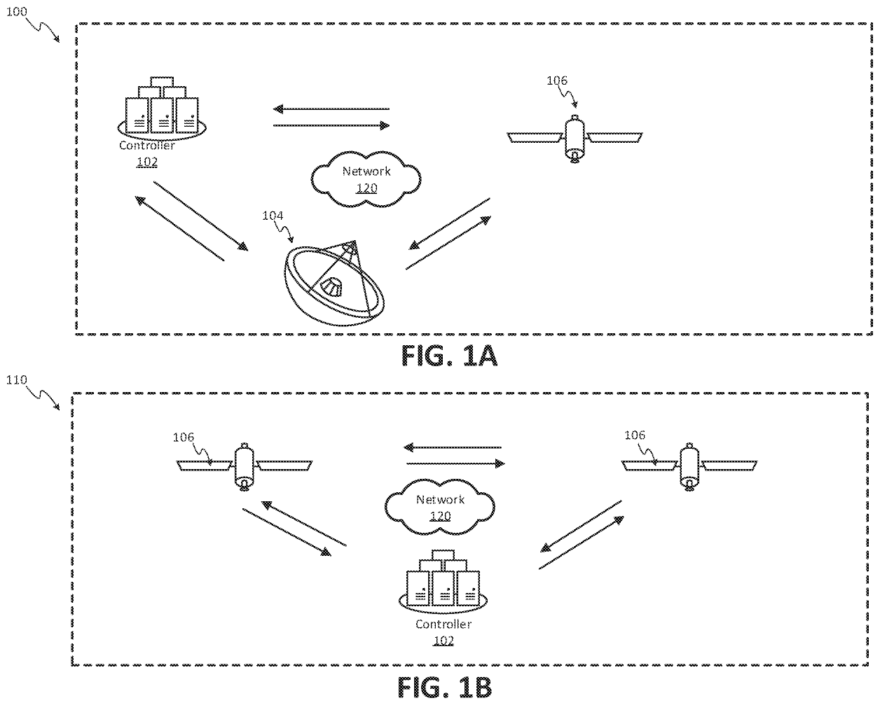

According to an exemplary embodiment, FIGS. 1A and 1B illustrate systems 100, 110, respectively, in which one or more disclosed embodiments may be implemented. The system 100 in FIG. 1A may include a controller 102 (e.g., processor) communicatively connected via a network 120 to one or more nodes. One of the nodes may include a ground station 104. Another one of the nodes may include a satellite 106. The satellite may be a low or medium earth orbit satellite. While not shown, system 100 may include another node such as for example a ground station or satellite. The controller 102, generally speaking, may coordinate the activities and data exchanges between one or more nodes. In an embodiment, the controller 102 may be integrated with one of the nodes in the system. For example, the controller may be integrated within the ground station 104 to form a singular unit. Alternatively, the controller 102 may be located remotely from the illustrated nodes at another node remote node or operate on a server.

The system 110 in FIG. 1B operates in a similar fashion as system 100 in FIG. 1A. Thus similar reference indicators will be preserved among both FIG. 1A and FIG. 1B. Instead of a ground station communicating with a satellite as depicted in FIG. 1A, FIG. 1B illustrates two satellites 106 in communication with each other and with controller 102. It is envisaged that both satellites 106 could be ground stations.

According to an embodiment, each of the nodes in the system may include a clock such as an OXCO, a CSAC, or an atomic clock including rubidium gas cells, cesium beams or hydrogen masers. In an embodiment, one of the nodes may include an OXCO while the other note includes a CSAC. In another embodiment, each of the nodes may include a similar clock type.

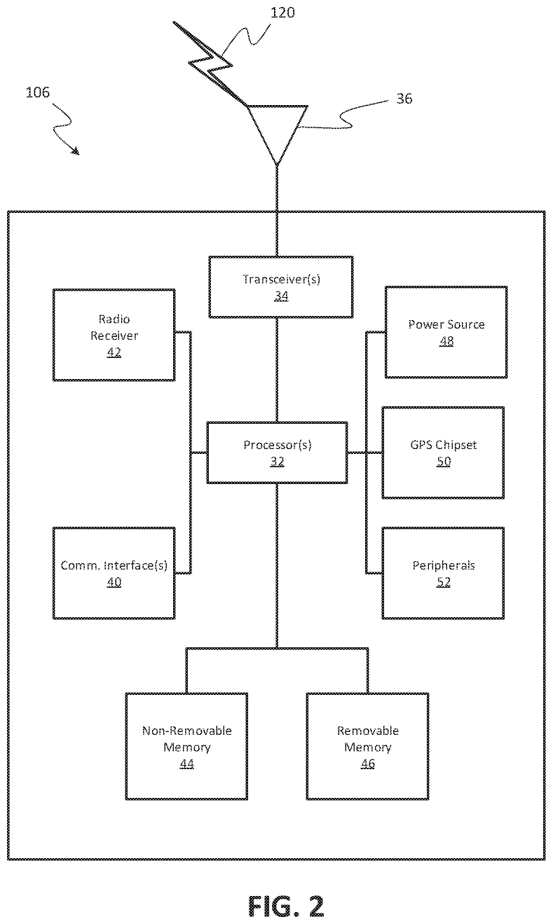

FIG. 2 is a block diagram of an exemplary hardware/software architecture of a node in a system of FIG. 1. As shown in FIG. 2, the node may be a satellite 106 or alternatively a ground station 104. As depicted in FIG. 2, the node is a satellite 106. The node 106 may include one or more processors 32, a communication interface 40, a radio receiver 42, non-removable memory 44, removable memory 46, a power source 48, a global positioning system (GPS) chipset 50, and other peripherals 52. The node 106 may also include communication circuitry, such as one or more transceivers 34 and a transmit/receive element 36. It will be appreciated that node 106 may include any sub-combination of the foregoing elements while remaining consistent with an embodiment.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., the non-removable memory 44 and/or the memory 46) of the node 106 in order to perform its various required functions.

The processor 32 is coupled to its communication circuitry (e.g., the transceiver 34, the transmit/receive element 36, the radio receiver 42, and the communication interface 40). The processor 32, through the execution of computer executable instructions, may control the communication circuitry in order to cause the node 106 to communicate with other components of the system, such as the ground station 104 and the controller 102 of FIG. 1A or 1B. The processor 32 may further control the communication circuitry to detect and capture radio spectrum and radio signal data via the transmit/receive element 36 and the radio receiver 42. The radio receiver 42 may comprise a software-defined radio (SDR) receiver. The radio receiver 42 may define one or more channels, such as one or more channels to scan a frequency spectrum for any radio signals associated with a primary user and one or more channels to capture identified radio signal data associated with a primary user.

The transmit/receive element 36 may be configured to receive (i.e., detect) a primary signal (e.g., from a ground station or another satellite) in the node's 106 RF environment. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals. The transceiver 34 and/or transmit/receive element 36 may be integrated with, in whole or in part, the communication interface(s) 40, particularly wherein a communication interface 40 comprises a wireless communication interface.

The processor 32 may access information from, and store data in, any type of suitable memory, such as the non-removable memory 44 and/or the removable memory 46. For example, the processor 32 may store captured radio signal data (e.g., FA packets and digital I&Q data) in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a USB drive, a secure digital (SD) memory card, and the like. In other embodiments, the processor 32 may access information from, and store data in, memory that is not physically located on the node 106. The non-removable memory 44, the removable memory 46, and/or other associated memory may comprise a non-transitory computer-readable medium configured to store instructions that, when executed, effectuate any of the various operations described herein.

The processor 32 may receive power from the power source 48 and may be configured to distribute and/or control the power to the other components in the node 106. The power source 48 may be any suitable device for powering the node 106. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The power source 48 may be additionally or alternatively configured to receive power from an external power source.

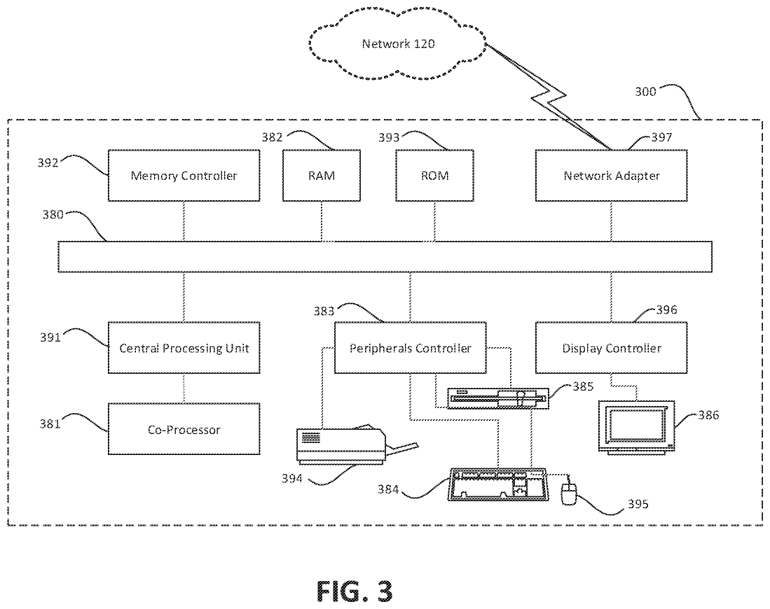

FIG. 3 depicts a block diagram of an exemplary computing system 300 which may be used coordinate with one or more components of the system, including node 106, ground station 104, and/or controller 102 of FIG. 1A or 1B. In one or more embodiments, the computing system may be, or form port of, controller 102. The computing system 300 may comprise a computer or server and may be controlled primarily by computer-readable instructions (e.g., stored on a non-transitory computer-readable medium), which may be in the form of software, wherever, or by whatever means such software is stored or accessed. Such computer-readable instructions may be executed within a processor, such as a central processing unit (CPU) 391, to cause the computing system 300 to do work. In many known workstations, servers, and personal computers, the CPU 391 is implemented by a single-chip CPU called a microprocessor. In other machines, the CPU 391 may comprise multiple processors. A coprocessor 381 is an optional processor, distinct from the CPU 391 that performs additional functions or assists the CPU 391. The CPU 391 and/or the coprocessor 381 may receive anomaly detection data from a node 106 to detect a primary signal in the node's 106 RF environment.

In operation, the CPU 391 fetches, decodes, executes instructions, and transfers information to and from other resources via the computer's main data-transfer path, system bus 380. Such a system bus connects the components in the computing system 300 and defines the medium for data exchange. The system bus 380 typically includes data lines for sending data, address lines for sending addresses, and control lines for sending interrupts and for operating the system bus 380. An example of such a system bus 380 may be the PCI (Peripheral Component Interconnect) bus or PCI Express (PCIe) bus.

Memories coupled to the system bus 380 include random access memory (RAM) 382 and read only memory (ROM) 393. Such memories include circuitry that allows information to be stored and retrieved. The RAM 382, the ROM 393, or other associated memory may comprise a non-transitory computer-readable medium configured to store instructions that, when executed, effectuate any of the various operations described herein. The ROMs 393 generally contain stored data that cannot easily be modified. Data stored in the RAM 382 may be read or changed by the CPU 391 or other hardware devices. Access to the RAM 382 and/or the ROM 393 may be operated by a memory controller 392. The memory controller 392 may provide an address translation function that translates virtual addresses into physical addresses as instructions are executed. The memory controller 392 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, the computing system 300 may comprise a peripherals controller 383 responsible for communicating instructions from the CPU 391 to peripherals, such as a printer 394, a keyboard 384, a mouse 395, and a disk drive 385. A display 386, which is controlled by a display controller 396, is used to display visual output generated by the computing system 300. Such visual output may include text, graphics, animated graphics, and video. Visual output may further comprise a GUI. The display 386 may be implemented with a CRT-based video display, an LCD-based flat-panel display, gas plasma-based flat-panel display, or a touch-panel. The display controller 396 includes electronic components required to generate a video signal that is sent to the display 386.

Further, the computing system 300 may comprise communication circuitry, such as a network adaptor 397, that may be used to connect the computing system 300 to a communications network, such as the network 120 of FIG. 1A or 1B, to enable the computing system 300 to communicate with other components of the system and network.

### Clock Model/Prediction

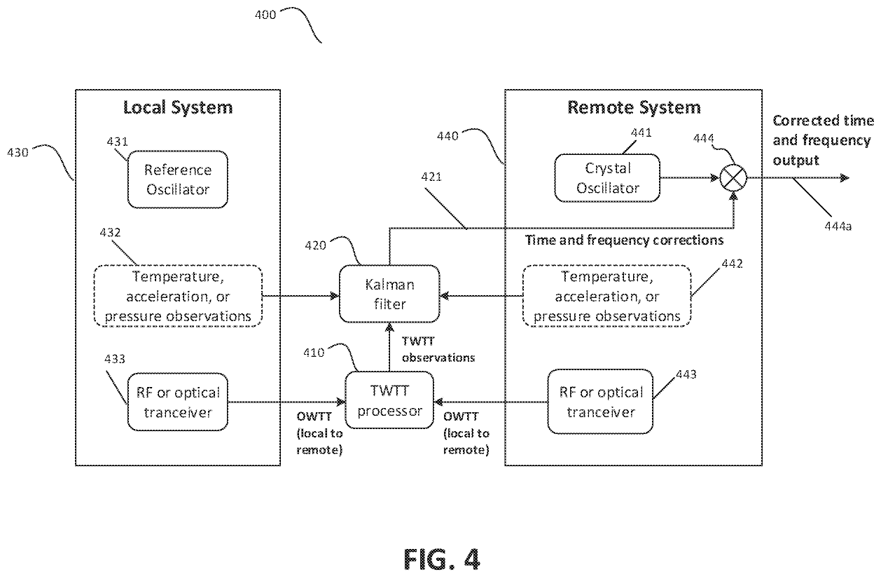

According to another aspect of the present application, a prediction technique and system are described by way of exemplary system 400 as illustrated in FIG. 4. As shown in system 400, there is a two-way time transfer (TWTT) processor 410 (e.g., or one-way time transfer (OWTT)), clock modelling Kalman filter software 420, local system 430, and remote system 440. FIG. 4 may be understood in its entirety when read in conjunction with FIG. 1. In one embodiment, controller 102 depicted in FIG. 1 may include TWTT processor 410 and/or Kalman filter software 420.

Each of local system 430 and remote system 440 may include an oscillator as described above. As depicted in FIG. 4, the local system 430 may include a reference oscillator 431, one or more sensors 432, and an RF or optical transceiver 433. The one or more sensors 432 may collect environmental input data including for example any one or more of temperature, acceleration, vibration or pressure. The box around sensors 432 in the local system 430 is shown in dashed lines. At least in one embodiment one or more of the sensory inputs may be optional. According to an embodiment, environmental input one or more of the sensors 432 may be transmitted to the Kalman filter software 420.

The local system 430 may also transmit data via its RF or optical transceiver 433 to processor 410. The data is transmitted via one-way time transfer (OWTT). The transmitted data may include one or more indications regarding expected bounds for frequency offset or frequency drift rate. The transmitted data may also include an indication of a measured phase noise spectrum. The phase noise spectrum may be inferred from a modified Allan variance or Hadamard variance plot.

As further depicted in FIG. 4, remote system 440 may include a crystal oscillator 441, one or more sensors 442, and an RF or optical transceiver 443. Similar to the local system 430, the box around the one or more sensors 442 is shown in dashed lines. This indicates the sensors may be optional in an embodiment. The box around sensors 442 in the remote system 440 is shown in dashed lines. At least in one embodiment one or more of the sensory inputs may be optional. According to an embodiment, environmental input one or more of the sensors 442 may be transmitted to the Kalman filter software 420.

Further depicted in FIG. 4, the remote system 440 may transmit data via its RF or optical transceiver 443 to processor 410. The data is transmitted via one-way time transfer (OWTT). The transmitted data may include one or more indications regarding expected bounds for frequency offset or frequency drift rate. The transmitted data may also include an indication of a measured phase noise spectrum. The phase noise spectrum may be inferred from a modified Allan variance or Hadamard variance plot.

As further depicted in FIG. 4, processor 410 may transmit the data obtained from the remote and local systems to the Kalman filter software 420. The data may include periodic time offset observations based upon uncertainties between a local and a remote clock.

According to another embodiment, the Kalman filter software 420 may estimate the relative time offset, frequency offset, frequency drift, phase noise and environmental influences between the remote and local systems (clocks).

Broadly, a running correction 421 may be output from the Kalman filter 420 in view of the aforementioned inputs. A means of adding the estimated timing and frequency corrections 421 to the remote clock output are envisaged. This may be done via a separate file containing corrections or as a software correction to its published timestamps. The correction 421 may be transmitted to a repository 444 located in the remote system 440. A corrected time and frequency 444a may be output from repository 444.

According to an embodiment, the system architecture 400 may be configured such that it does not rely upon GNSS. The system architecture 400 may also be configured to be independent of UTC or another global standard.

### Time Offset

The time offset between a remote and a local clock if both operate at nominal frequency f_{c} is given by:

$$Δ {t}_{RL} = Δ t + \frac{1}{{f}_{c}} {\int }_{0}^{T} Δ {f}^{env} dt + \frac{1}{{f}_{c}} ( Δ fT + \frac{1}{2} Δ \dot{f} {T}^{2} + … ) + \frac{1}{{f}_{c}} {\int }_{0}^{T} δ {f}_{RL} dt$$

where Δt is the initial time offset in seconds, Δf^{env} is the time-varying frequency shift in Hertz due to all environmental influences,

$$\frac{1}{{f}_{c}} ( Δ fT + \frac{1}{2} Δ \dot{f} {T}^{2} + … )$$

is a polynomial model for frequency difference in Hertz where the first term is the frequency offset, the second is the frequency drift, and subsequent terms are optional as necessary to faithfully model a given pair of clocks. The last term,

$$\frac{1}{{f}_{c}} {\int }_{0}^{T} δ {f}_{RL} dt ,$$

is the integrated phase noise difference between the two clocks. The approach used here is to compute the environmental term, estimate the initial time offset and frequency difference parameters, and model the correlation structure of the phase noise. Our prototype implementation employs a Kalman filter to estimate all unknowns and provide a mechanism for predicting the time and frequency difference and their uncertainties between time or frequency offset observations.

In an embodiment of the present application, the Kalman filter update interval (Δt) is preferably short and constant. The update interval Δt must be small enough such that, for all timestamps t_{obs} of TWTT observations, δy mod(t_{obs}, Δt)«σ_{obs} where δy is the magnitude of the relative frequency offset between the clocks and σ_{obs} is the TWTT uncertainty in seconds. This criterion guarantees the discrete nature of the update interval will have little to no discernible effect upon the filter output.

Doing so provides other realized benefits. First, environmental factors can be monitored locally and at a high frequency and therefore tracked on a short time scale. Second, the correlation structure of the phase noise encapsulated in the process noise matrix and state variables can be faithfully preserved. The update interval is chosen to be short compared to environmental timescales and short enough that as asynchronous TWTT/TWFT observations arrive, their observation times match closely enough to the nearest update time that no significant errors are introduced.

### Kalman Filter Model

According to an aspect of the application, the time offset equation indicated above is in terms of relative time error x=Δt/τ and relative frequency error y=Δf/f_{c} where τ is the time between Kalman filter steps. The state vector employed in our prototype system is given by:

\vec{X}=[x y \dot{y} yₑₙᵥ m₁ m₂ m₃ m₄]^{T}

Here, the first four terms as described above and m₁ through m₄ are four Markov frequency parameters as understood in the art. The state propagation matrix is:

$$Φ = [ \begin{matrix}1 & 1 & 0.5 & 1 & \frac{( 1 - exp ( - {R}_{1} τ ) )}{( {R}_{1} )} & \frac{( 1 - exp ( - {R}_{2} τ ) )}{( {R}_{2} )} & \frac{( 1 - exp ( - {R}_{3} τ ) )}{( {R}_{3} )} & \frac{1 - exp ( - {R}_{4} τ )}{{R}_{4}} \\ 0 & 1 & 1 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & exp ( - {R}_{1} τ ) & 0 & 0 & 0 \\ 0 & 0 & 0 & 0 & 0 & exp ( - {R}_{2} τ ) & 0 & 0 \\ 0 & 0 & 0 & 0 & 0 & 0 & exp ( - {R}_{3} τ ) & 0 \\ 0 & 0 & 0 & 0 & 0 & 0 & 0 & exp ( - {R}_{4} τ )\end{matrix} ] .$$

Here, Rₖ=0.75×8^{1-k}. The environmentally induced relative frequency variation (yₑₙᵥ) may be considered a measured quantity given by the sum of all monitored effects shown below.

yₑₙᵥ=γₜₑₘₚyₜₑₘₚ+γ_{accel}y_{accel}+γₚᵣₑₛₛᵤᵣₑyₚᵣₑₛₛᵤᵣₑ

Here, the γ's are presence/absence flags (=1 when observation is available, =0 if not). The quantities yₜₑₘₚ, y_{accel} and yₚᵣₑₛₛᵤᵣₑ are functions of observed temperature, acceleration, and pressure, respectively. They may be simple analytical functions or AI-derived functions of a sequence of past values, obtained by regressing against test data. The design matrices for the different types of observations are

Hₓ=[1 0 0 0 0 0 0 0]

H_{y}=[0 1 0 1 0 0 0 0]

and

H_{y}_{ₑₙᵥ}=[0 0 0 1 0 0 0 0].

The observation covariance for the environmentally induced relative frequency variation is:

$${σ}_{{y}_{env}}^{2} = {{γ}_{temp} ( \frac{\partial {y}_{temp}}{\partial T} )}^{2} {σ}_{T}^{2} + {{γ}_{accel} ( \frac{\partial {y}_{accel}}{\partial A} )}^{2} {σ}_{A}^{2} + {{γ}_{temp} ( \frac{\partial {y}_{pressure}}{\partial P} )}^{2} {σ}_{P}^{2}$$

Here, T, A and P correspond to temperature, acceleration, and pressure, respectively. Acceleration in this context means along the direction of frequency sensitivity. This formulation allows for nonlinear variation of each environmental effect. Another variable, while not recited above, may be radiation-induced effects for an oscillator.

The initial state and covariances are defined in a system-dependent way. That is, if there is some coarse timing alignment before the clock modeling system is started then those state values and uncertainties are used to define the initial state and covariance. If no a priori information is available then the state values are zeroed and the covariance values are set to their maximum theoretical values (based on hardware specifications).

The process noise model is specific to the two clocks used and is the sum of the individual process noise covariances since each clock can be assumed to have independent phase noise. For example, if one clock dominated by flicker frequency modulation phase noise is selected and a reference clock with insignificant phase noise is also selected, then the process noise covariance would take the form:

$$Q = [ \begin{matrix}{Q}_{xx} & 0 & 0 & 0 & {τ}^{2} {a}_{12} ( {R}_{1} τ ) {σ}_{m}^{2} & {τ}^{2} {a}_{12} ( {R}_{2} τ ) {σ}_{m}^{2} & {τ}^{2} {a}_{12} ( {R}_{3} τ ) {σ}_{m}^{2} & {τ}^{2} {a}_{12} ( {R}_{4} τ ) {σ}_{m}^{2} \\ 0 & 0 & 0 & 0 & 0 & 0 & 0 & 0 \\ 0 & 0 & 0 & 0 & 0 & 0 & 0 & 0 \\ 0 & 0 & 0 & {Q}_{env} & 0 & 0 & 0 & 0 \\ {τ}^{2} {a}_{12} ( {R}_{1} τ ) {σ}_{m}^{2} & 0 & 0 & 0 & {τ}^{2} {a}_{22} ( {R}_{1} τ ) {σ}_{m}^{2} & 0 & 0 & 0 \\ {τ}^{2} {a}_{12} ( {R}_{2} τ ) {σ}_{m}^{2} & 0 & 0 & 0 & 0 & {τ}^{2} {a}_{22} ( {R}_{2} τ ) {σ}_{m}^{2} & 0 & 0 \\ {τ}^{2} {a}_{12} ( {R}_{3} τ ) {σ}_{m}^{2} & 0 & 0 & 0 & 0 & 0 & {τ}^{2} {a}_{22} ( {R}_{3} τ ) {σ}_{m}^{2} & 0 \\ {τ}^{2} {a}_{12} ( {R}_{4} τ ) {σ}_{m}^{2} & 0 & 0 & 0 & 0 & 0 & 0 & {τ}^{2} {a}_{22} ( {R}_{4} τ ) {σ}_{m}^{2}\end{matrix} ] .$$

The upper left element Qₓₓ is given by:

$${Q}_{xx} = {τ}^{2} {a}_{11} ( {R}_{1} τ ) {σ}_{m}^{2} + {τ}^{2} {a}_{11} ( {R}_{2} τ ) {σ}_{m}^{2} + {τ}^{2} {a}_{11} ( {R}_{3} τ ) {σ}_{m}^{2} + {τ}^{2} {a}_{11} ( {R}_{4} τ ) {σ}_{m}^{2}$$

$$where \\ {a}_{11} ( x ) = \frac{- \frac{3}{2} + x + exp ( x ) - exp ( - 2 x ) / 2}{{x}^{3}} \\ {a}_{12} ( x ) = \frac{\frac{1}{2} - exp ( x ) + exp ( - 2 x ) / 2}{{x}^{2}} \\ and \\ {a}_{22} ( x ) = \frac{1 - exp ( - 2 x )}{2 x} .$$

The symbol σₘ denotes the individual Markov frequency component uncertainty. The term Qₑₙᵥ is the sum of the process noise variances of each of the contributing environmental relative frequency factors for a single time step τ. These terms must generally be learned from simulations or empirical results as they depend upon the rate of time variation of each of the factors.

While the process noise given here is one specific example, it will vary on a case-by-case basis. However, it is always given by the sum of six covariances (three for each clock). These include the environmental relative frequency covariance, phase noise covariance, and clock model covariance. The clock model covariance is required if the Kalman filter state is only an approximation to the underlying clock frequency drift behavior. In that case it captures the magnitude of the errors introduced by truncating the Kalman filter state.

### ML

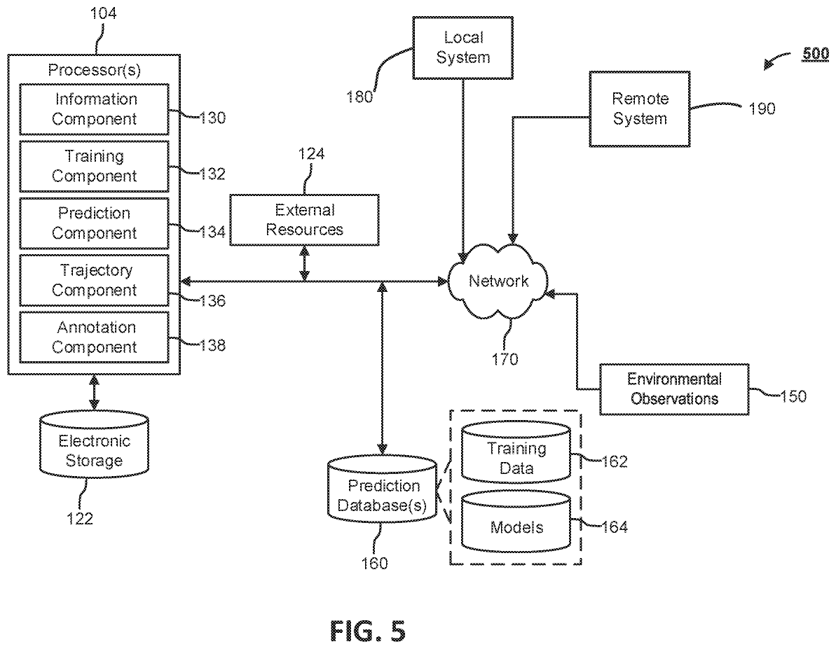

As envisaged in the application, and particularly in regard to the system 500 shown in the exemplary embodiment in FIG. 5, the terms artificial neural network (ANN) and neural network (NN) may be used interchangeably. An ANN may be configured to determine a classification (e.g., time and frequency corrections) based on identified information. An ANN is a network or circuit of artificial neurons or nodes, and may be used for predictive modeling. The prediction models may be and/or include one or more neural networks (e.g., deep neural networks, artificial neural networks, or other neural networks), other ML models, or other prediction models.

Disclosed implementations of ANNs may apply a weight and transform the input data by applying a function, where this transformation is a neural layer. The function may be linear or, more preferably, a nonlinear activation function, such as a logistic sigmoid, Tanh, or ReLU function. Intermediate outputs of one layer may be used as the input into a next layer. The neural network through repeated transformations learns multiple layers that may be combined into a final layer that makes predictions. This training (i.e., learning) may be performed by varying weights or parameters to minimize the difference between predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. In an exemplary embodiment, hyperparameters are set before learning and model parameters can be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values. Based on the results of training, the hyperparameters can be set to optimal values that provide a stable learning rate and accuracy.

A convolutional neural network (CNN) may comprise an input and an output layer, as well as multiple hidden layers. The hidden layers of a CNN typically comprise a series of convolutional layers that convolve with a multiplication or other dot product. The activation function is commonly a ReLU layer and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

In some embodiments, the learning of models 164 may be of reinforcement, supervised, semi-supervised, and/or unsupervised type. For example, there may be a model for certain predictions that is learned with one of these types but another model for other predictions may be learned with another of these types.

Supervised learning is the ML task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of ML that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data).

Semi-supervised learning makes use of supervised and unsupervised techniques described above. The supervised and unsupervised techniques may be split evenly for semi-supervised learning. Alternatively, semi-supervised learning may involve a certain percentage of supervised techniques and a remaining percentage involving unsupervised techniques.

Models 164 may analyze made predictions against a reference set of data called the validation set. In some use cases, the reference outputs resulting from the assessment of made predictions against a validation set may be provided as an input to the prediction models, which the prediction model may utilize to determine whether its predictions are accurate, to determine the level of accuracy or completeness with respect to the validation set, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 132 in the system 500 illustrated in FIG. 5 may implement an algorithm, such as for example employing the Kalman filter, for building and training one or more deep neural networks. In some embodiments, training component 132 may train a deep learning model on training data 162 providing even more accuracy after successful tests with these or other algorithms are performed and after the model is provided a large enough dataset.

In an exemplary embodiment, a model implementing a neural network may be trained using training data from storage/database 160. For example, the training data obtained from prediction database 160 of FIG. 5 may comprise hundreds, thousands, or even many millions of pieces of information. The training data may also include environmental observations 150. These may include but are not limited to temperature, acceleration, pressure or radiation-induced observations. Weights for each of the model parameters may be adjusted through training.

The training dataset may be split between training, validation, and test sets in any suitable fashion. For example, some embodiments may use about 60% or 80% of the known training data for training or validation, and the other about 40% or 20% may be used for validation or testing. In another example, training component 132 may randomly split the data, the exact ratio of training versus test data varies throughout. When a satisfactory model is found, training component 132 may train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 164 may be employed via training component 132.

In some embodiments, training component 132 may be configured to obtain training data from any suitable source, e.g., via prediction database 160, electronic storage 122, external resources 124, and/or network 170.

In some embodiments, training component 132 may enable one or more prediction models 164 to be trained. The training of the neural networks may be performed via several iterations. For each training iteration, a classification prediction (e.g., output of a layer) of the neural network(s) may be determined and compared to the corresponding, known classification. For example, sensed data known to capture a closed environment comprising dynamic and/or static objects may be input, during the training or validation, into the neural network to determine whether the prediction model may properly predict timing offsets.

Electronic storage 122 of FIG. 5 comprises electronic storage media that electronically stores information. The electronic storage media of electronic storage 122 may comprise system storage that is provided integrally (i.e., substantially non-removable) with a system and/or removable storage that is removably connectable to a system via, for example, a port (e.g., a USB port, a firewire port, etc.) or a drive (e.g., a disk drive, etc.). Electronic storage 122 may be (in whole or in part) a separate component within the system, or electronic storage 122 may be provided (in whole or in part) integrally with one or more other components of a system. In some embodiments, electronic storage 122 may be located in a server together with processor 102, or in a server that is part of external resources 124. Electronic storage 122 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 122 may store software algorithms, information obtained and/or determined by processor 102 and/or other external computing systems, information received from external resources 124, and/or other information that enables system to function as described herein.

External resources 124 may include sources of information (e.g., databases, websites, etc.), external entities participating with a system, one or more servers outside of a system, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 124 may be provided by other components or resources included in the system. Processor 102, external resources 124, electronic storage 122, a network, and/or other components of the system may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

Data and content may be exchanged between the various components of the system through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose, the Internet Protocol (IP) defines addressing methods and structures for datagram encapsulation. Of course, other protocols also may be used. Examples of an Internet protocol include Internet Protocol version 4 (IPv4) and Internet Protocol version 6 (IPv6).

In some embodiments, processor 102 may form part (e.g., in a same or separate housing) of a user device, a consumer electronics device, a mobile phone, a smartphone, a personal data assistant, a digital tablet/pad computer, a wearable device (e.g., watch), a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 102 is configured to provide information processing capabilities in the system. Processor 102 may comprise one or more of a digital processor, an analog processor, a digital circuit designed to process information, an analog circuit designed to process information, a state machine, and/or other mechanisms for electronically processing information. Although processor 102 is shown in FIG. 5 as a single entity, this is for illustrative purposes only. In some embodiments, processor 102 may comprise a plurality of processing units. These processing units may be physically located within the same device (e.g., a server), or processor 102 may represent processing functionality of a plurality of devices operating in coordination (e.g., one or more servers, devices that are part of external resources 124, electronic storage 122, and/or other devices).

As shown in FIG. 5, processor 102 is configured via machine-readable instructions to execute one or more computer program components. The computer program components may comprise one or more of information component 131, training component 132, prediction component 134, annotation component 136, trajectory component 38, and/or other components. Processor 102 may be configured to execute processor components 131, 132, 134, 136, and/or 138 by: software; hardware; firmware; some combination of software, hardware, and/or firmware; and/or other mechanisms for configuring processing capabilities on processor 102.

It should be appreciated that although processor components 131, 132, 134, 136, and 138 are illustrated in FIG. 5 as being co-located within a single processing unit, in embodiments in which processor 102 comprises multiple processing units, one or more of processor components 131, 132, 134, 136, and/or 138 may be located remotely from the other components. For example, in some embodiments, each of processor components 131, 132, 134, 136, and 138 may comprise a separate and distinct set of processors. The description of the functionality provided by the processor components 131, 132, 134, 136, and/or 138 described below is for illustrative purposes, and is not intended to be limiting, as any of processor components 131, 132, 134, 136, and/or 138 may provide more or less functionality than is described. For example, one or more of processor components 131, 132, 134, 136, and/or 138 may be eliminated, and some or all of its functionality may be provided by other processor components 131, 132, 134, 136, and/or 138. As another example, processor 102 may be configured to execute one or more additional components that may perform some or all of the functionality attributed below to one of processor components 131, 132, 134, 136, and/or 138.

Concurrently, the processor 102 may employ one or more of the trained ML models 164 in the predication database 160, based upon the training data 162, to evaluate an offset between local system 180 and remote system 190.

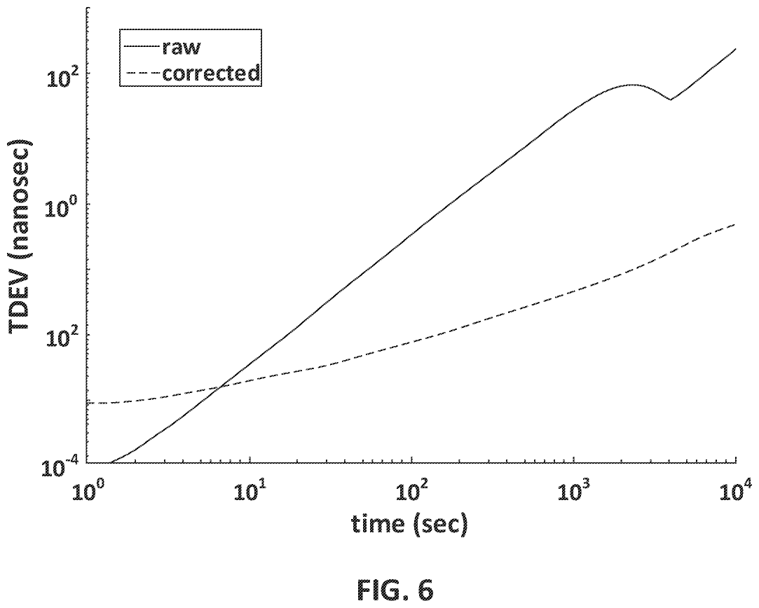

According to a further embodiment of the application, FIG. 6 illustrates a plot of a raw OXCO clock output (solid line) versus a model-corrected output (dashed lines). This example assumed a perfect reference clock and a remote clock with only FFM (flicker frequency modulation) phase noise at the 10⁻¹³ level. The remote clock was subject to a sinusoidal temperature variation with a 90 minute period and 10° C. amplitude (frequency sensitivity of

$${10}^{- 11} \frac{Hz}{Hz} / ° C . ) .$$

The corrected clock has roughly 100 times smaller time variation at the temperature variation time scale.

According to an exemplary use case of the application, there are two clocks. One is an ideal local reference clock on the ground (insignificant phase noise and no frequency error). There other is an OXCO located in an orbiting spacecraft. The spacecraft clock orbits earth every 90 minutes and is subject to 10° C. amplitude sinusoidal temperature variation with the same period. There is a temperature probe on the clock that produces a measurement every second with 0.1° C. uncertainty, and there are no acceleration or pressure effects. The temperature sensitivity is

$${10}^{- 11} \frac{Hz}{Hz} / ° C . ,$$

frequency offset is

$${10}^{- 9} \frac{Hz}{Hz} ,$$

and the frequency drift rate is

$$- 6 \times {10}^{- 15} \frac{Hz}{Hz} / sec .$$

In this example, TWTT measurements with 100 picosecond accuracy are made every 90 minutes. As shown by the plot, frequency offset and drift are almost completely removed. In addition, the time-varying temperature effect on both time and frequency are also almost completely removed.

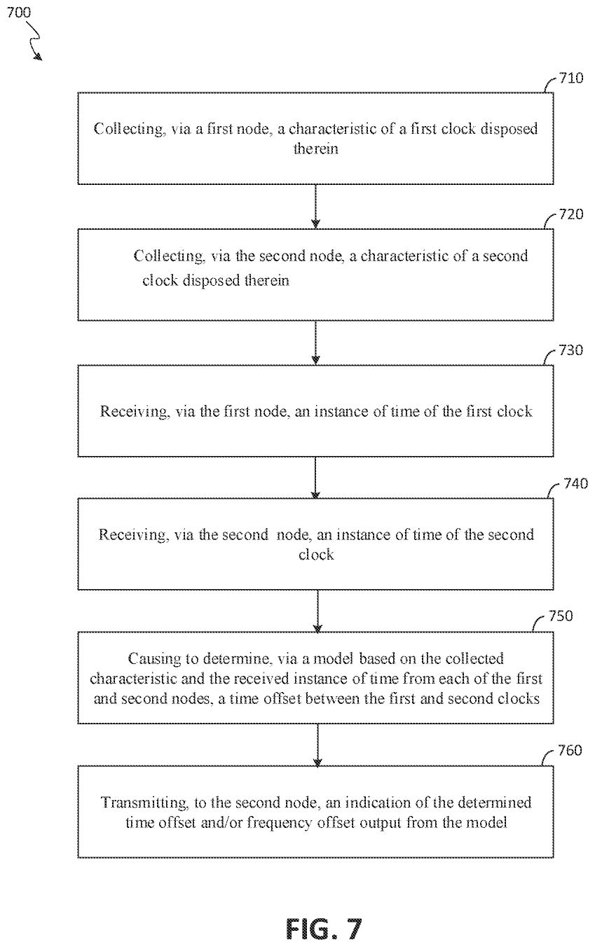

According to yet another aspect of the application, an exemplary method for predicting an output is described. FIG. 7 illustrates a flow diagram 700. The steps may be performed by a controller, such as for example the controller 102 illustrated in FIG. 1A, 1B or 5, or in computing system 300 illustrated in FIG. 3. As depicted in in FIG. 7, a characteristic of a first clock located in a first node is collected (Step 710). Next, a characteristic of a second clock located in a second node is collected (Step 720). Subsequently, an instance of time of the first clock of the first node is received from the first node (Step 730). Thereafter, an instance of time of the second clock of the second node is received (Step 740). Further, a controller may cause to determine a time offset and/or frequency offset between the first and second clocks (Step 750). The controller may employ a model fed with the collected characteristic and the received instance of time from each of the first and second nodes. Even further, an indication of the determined time offset output from the model may be transmitted to the second node (Step 760).

In one or more embodiments, the method may further include a step of receiving feedback from the second node that an output of the second node has been updated in view of the transmission. Here, the feedback may indicate synchronization of less than or equal to 1 microsecond between the first and second clocks. The update may include a correction to a published timestamp of the second clock.

In one or more further embodiment, the method may include a step of evaluating whether the time offset falls outside of acceptable synchronization bounds. The method may also include a step of causing to reset the first and second clocks to substantially match one another based upon the evaluation.

While the systems and methods have been described in terms of what are presently considered specific embodiments, the disclosure need not be limited to the disclosed embodiments. It is intended to cover various modifications and similar arrangements included within the spirit and scope of the claims, the scope of which should be accorded the broadest interpretation to encompass all such modifications and similar structures. The present disclosure includes any and all embodiments of the following claims.

What is claimed is:

1. A method comprising:
collecting, via a first node, a characteristic of a first clock disposed therein;
collecting, via a second node, a characteristic of a second clock disposed therein;
receiving, via the first node, an instance of time of the first clock;
receiving, via the second node, an instance of time of the second clock;
causing to determine, via a model based on the collected characteristic and the received instance of time from each of the first and second nodes, a time offset and/or frequency offset between the first and second clocks; and
transmitting, to the second node, an indication of the determined time offset and/or frequency offset output from the model.

2. The method of claim 1, further comprising:
receiving, from the second node, feedback that an output of the second node has been updated in view of the transmission.

3. The method of claim 2, wherein the feedback indicates synchronization of less than or equal to 1 microsecond between the first and second clocks.

4. The method of claim 2, wherein the update includes a correction to a published timestamp of the second clock.

5. The method of claim 1, further comprising:
evaluating whether the time offset falls outside of acceptable synchronization bounds; and
causing to reset the first and second clocks to substantially match one another based upon the evaluation.

6. The method of claim 1, wherein the first clock or the second clock includes any one or more of a crystal oscillator, a chip scale atomic clock, or an atomic clock including rubidium gas cells, cesium beams or hydrogen masers.

7. The method of claim 1, wherein the characteristic includes any one or more of an environmental condition, a predetermined bound for a frequency offset, a predetermined bound for a frequency drift rate or a phase noise spectrum.

8. The method of claim 7, wherein the environmental condition includes any one or more of temperature, acceleration, vibration, pressure or radiation.

9. The method of claim 1, wherein the model includes a Kalman filter.

10. The method of claim 1, wherein the model is a machine learning model.

11. The method of claim 1, wherein the determination includes a frequency offset wherein the frequency offset includes any one or more of a frequency drift, a phase noise or an environmental influence.

12. The method of claim 1, wherein noise detected via the model is based upon any one or more of an environmental relative frequency covariance, phase noise covariance and clock model covariance derived from the first or second nodes.

13. A system comprising:
a non-transitory memory including instructions stored thereon; and
a processor operably coupled to the non-transitory memory being configured to execute the instructions including:
collecting, via a first node, a characteristic of a first clock disposed therein;
collecting, via a second node, a characteristic of a second clock disposed therein;
receiving, via the first node, an instance of time of the first clock;
receiving, via the second node, an instance of time of the second clock; and
causing to determine, via a model based on the collected characteristic and the received instance of time from each of the first and second nodes, a time offset and/or frequency offset between the first and second clocks,
wherein the first clock or the second clock includes any one or more of a crystal oscillator, a chip scale atomic clock, or an atomic clock including rubidium gas cells, cesium beams or hydrogen masers.

14. The system of claim 13, wherein the processor is further configured to execute the instructions of:
transmitting, to the second node, an indication of the determined time offset and/or frequency offset output from the model; and
receiving, from the second node, feedback that an output of the second node has been updated in view of the transmission.

15. The system of claim 14, wherein the feedback indicates synchronization of less than or equal to 1 microsecond between the first and second clocks.

16. The system of claim 14, wherein the update includes a correction to a published timestamp of the second clock.

17. The system of claim 13, wherein the processor is further configured to execute the instructions of
evaluating whether the time offset falls outside of acceptable synchronization bounds; and
causing to reset the first and second clocks to substantially match one another based upon the evaluation.

18. The system of claim 13, wherein the characteristic includes any one or more of an environmental condition, a predetermined bound for a frequency offset, a predetermined bound for a frequency drift rate or a phase noise spectrum.

19. The system of claim 18, wherein the environmental condition includes any one or more of temperature, acceleration, vibration, pressure or radiation.

20. The system of claim 13, wherein the determination includes a frequency offset wherein the frequency offset includes any one or more of a frequency drift, a phase noise or an environmental influence.
